(19) United States
(12) Patent Application Publication
(10) Pub. No.: US 2002/0000989 A1
(43) Pub. Date: Jan. 3, 2002

(54) Display control apparatus and method

(76) Inventor: Tatsuya Suzuki, Shinagawa (JP)

Correspondence Address: STAAS & HALSEY LLP, 700 11TH STREET, NW, SUITE 500, WASHINGTON, DC, 20001, US

(21) Appl. No.: 09/772,925

(22) Filed: Jan. 31, 2001

(30) Foreign Application Priority Data
Jul. 3, 2000 (JP) 2000-201122

(51) Int. Cl. G06T 11/00

(52) U.S. Cl. 345/472

(57) ABSTRACT

Enlargement processing sections enlarge picture data supplied from a VRAM in accordance with enlargement algorithms of their own and output the picture data to a mode selecting section through an enlargement processing selecting section. The mode selecting section selects one of the picture data supplied from the VRAM and enlargement processing selecting sections on the basis of a display mode selection signal supplied from a control section and outputs the picture data to a display section. With this construction, while keeping the picture data supplied from the VRAM displayed on the display section, the picture data is enlarged and output to the mode selecting section, so the normal display image and the enlargement display image can be instantaneously switched only by switching the mode selecting section without rewriting the picture data in the VRAM.

### CROSS-REFERENCE TO RELATED APPLICATIONS

This application is based upon and claims priority of Japanese Patent Application No. 2000-201122, filed on Jul. 3, 2000, the contents being incorporated herein by reference.

### BACKGROUND OF THE INVENTION

1. Field of the Invention

The present invention relates to display control apparatus and methods, in particular, for enlarging/reducing an image in a display picture in order to display the image on a display device of a portable device or the like.

2. Description of the Related Art

A portable device such as a portable telephone or PDA (Personal Digital Assistants) has been conventionally required to be lightweight and compact. Due to this requirement, the display device of a portable device has also been required to be compact and display many pieces of information easy to see even in a small display picture size.

FIG. 1 is a block diagram showing the construction of a display control apparatus for a conventional portable device.

Referring to FIG. 1, a control section 1 supplies the picture data of the display picture to be displayed on a display section 4 to a VRAM (Video Random Access Memory) 3 or instructs a display controller 2 to output the address of the VRAM 3, at which the picture data is stored.

In addition, when an image displayed in the display picture of the display section 4 is to be enlarged/reduced, the control section 1 reads out the picture data of the display picture stored in the VRAM 3, and stores and saves the picture data in a memory 5. The control section 1 executes predetermined processing for the readout picture data in accordance with a predetermined enlargement algorithm or reduction algorithm of its own and writes the data back to the VRAM 3.

On the basis of an instruction from the control section 1, the display controller 2 outputs, to the VRAM 3, the address at which picture data to be displayed on the display section 4 is stored. The VRAM 3 stores picture data supplied from the control section 1. The VRAM 3 outputs stored picture data to the display section 4 on the basis of an address supplied from the display controller 2.

The display section 4 constructed by, e.g., an LCD (Liquid Crystal Display) displays an image according to picture data supplied from the VRAM 3. The memory 5 saves the picture data of the display picture stored in the VRAM 3 when the image displayed in the display picture of the display section 4 is to be enlarged/reduced.

The operation of the display control apparatus shown in FIG. 1 will be described next.

The control section 1 writes, in the VRAM 3, the picture data of a display image to be displayed on the display section 4. When the control section 1 instructs the display controller 2 to output the address at which the picture data is stored, the display controller 2 outputs the address to the VRAM 3. The VRAM 3 outputs the picture data stored at that address to the display section 4. With this operation, the image according to the picture data stored in the VRAM 3 is displayed on the display section 4, as shown in FIGS. 2A and 2B. FIG. 2A shows the contents of the picture data in the VRAM 3, and FIG. 2B shows the display image obtained by displaying the picture data in the VRAM 3 on the display section 4. The picture data in the VRAM 3 is displayed in the display picture of the display section 4 without any change in its contents.

Assume that the user of the portable device performs predetermined operation to request the control section 1 to enlarge or reduce the image displayed on the display section 4. Upon receiving the request, the control section 1 reads out the picture data of the display image displayed on the display section 4 from the VRAM 3. The control section 1 saves the read-out picture data in the memory 5 and executes predetermined processing for the read-out picture data in accordance with a predetermined enlargement algorithm or reduction algorithm which is incorporated in the control section 1 as a program.

Additionally, the control section 1 writes back the picture data that has undergone the predetermined processing to the address of the VRAM 3 where the picture data before processing was stored. When this written back picture data is output from the VRAM 3 to the display section 4, an enlarged or reduced image is displayed on the display section 4.

To display the original image before enlargement or reduction while keeping the enlarged or reduced image displayed on the display section 4, the control section 1 reads out the picture data saved in the memory 5 and writes the picture data back to the VRAM 3. With this operation, the picture data before processing is output from the VRAM 3 to the display section 4, and an image corresponding to the picture data before processing is displayed on the display section 4.

FIGS. 3A to 3C are illustrations showing examples of processing of the enlargement algorithm of the control section 1. FIGS. 3A to 3C show processing of vertically and horizontally enlarging an image into double.

FIG. 3A shows picture display of picture data before enlargement processing. FIG. 3B shows picture display when the picture data displayed as in FIG. 3A is processed using a simple enlargement algorithm for simply vertically and horizontally enlarging an image. By this simple enlargement algorithm, an image obtained by faithfully vertically and horizontally enlarging each dot of picture data before processing is displayed.

FIG. 3C shows picture display when the picture data displayed as in FIG. 3A is processed using an interpolation enlargement algorithm for vertically and horizontally enlarging an image and also executing interpolation processing. In the interpolation processing, an image is interpolated by vertically and horizontally enlarging a portion where dots in the same color (density) obliquely line up, i.e., a portion where only one vertex of each dot is in contact in the picture before enlargement display, and then, adding dots in the same color (density) to surround the vertex. In this interpolation enlargement algorithm, an oblique dot array is displayed more smoothly than in the simple enlargement algorithm.

FIGS. 4A to 4C are illustrations showing examples of display images enlarged using the enlargement algorithm of the control section 1.

FIG. 4A shows a display image before enlargement processing, in which a circle and a cross laid out in the circle are displayed by dark dots. The vertical and horizontal lines of the cross have a 1-dot width, and the intersection between the vertical line and the horizontal line has a white dot. In addition, triangles having the center of the display picture as vertices and the left and right sides of the display picture as bases, and the interiors of the triangles are displayed by light dots.

When a portion surrounded by a dotted frame 80 in the display image shown in FIG. 4A is enlarged by the simple enlargement algorithm, a display image shown in FIG. 4B is obtained. Referring to FIG. 4B, since picture data before enlargement processing is faithfully enlarged in the vertical and horizontal directions, the image has the same shape as that in the picture data before enlargement processing.

When the portion surrounded by the dotted frame 80 in the display image shown in FIG. 4A is enlarged by the interpolation enlargement algorithm, a display image shown in FIG. 4C is obtained. Referring to FIG. 4C, since the picture data before enlargement processing is vertically and horizontally enlarged, and simultaneously, interpolation processing is executed, a portion 81 where dots in the same color (density) obliquely line up is smoothly displayed. On the other hand, at an intersection portion 82 of the cross, since dots in the same color (density) obliquely line up in the display image before enlargement processing, the white dot portion before enlargement is interpolated and changes to a dark dot.

FIGS. 5A to 5C are illustrations showing examples of processing of the reduction algorithm of the control section 1. FIGS. 5A to 5C show processing of vertically and horizontally reducing an image into half.

FIG. 5A shows picture display of picture data before reduction processing. The picture display shown in FIG. 5A is constituted by 16×16 dots. In the (2n+1)th rows (n=0 to 4), dark dots line up in the first to (2n+1)th columns (n=0 to 4). In the (2n+1)th columns (n=0 to 4), dark dots line up in the first to (2n+1)th rows (n=0 to 4). For example, in the fifth row, dark dots line up in the first to fifth columns, and in the fifth column, dark dots line up in the first to fifth rows. The dots are connected, so a dark line bent at a right angle at the fifth row and column position is displayed.

Similarly, in the 2n-th rows (n=4 to 8), dark dots line up in the 2n-th to 16th columns (n=4 to 8). In the 2n-th columns (n=4 to 8), dark dots line up in the 2n-th to 16th rows (n=4 to 8). For example, in the 12th row, dark dots line up in the 12th to 16th columns, and in the 12th column, dark dots line up in the 12th to 16th rows. The dots are connected, so a dark line bent at a right angle at the 12th row and column position is displayed.

FIG. 5B shows picture display when the picture display as in FIG. 5A is processed using an odd delete reduction algorithm. In this odd delete reduction algorithm, dots of odd-numbered rows and columns in picture display are deleted. Hence, the dark dots of the (2n+1)th rows (n=0 to 4) and (2n+1)th columns (n=0 to 4) displayed in FIG. 5A are deleted. In addition, the dark dots of the 2n-th rows (n=4 to 8) and 2n-th columns (n=4 to 8) form a solid square because adjacent odd-numbered rows and columns are deleted to eliminate the white portions.

FIG. 5C shows picture display when the picture display as in FIG. 5A is processed using an even delete reduction algorithm. This even delete reduction algorithm is different from the odd delete reduction algorithm shown in FIG. 5B only in the rows and columns to be deleted. As in FIG. 5B, the white portions disappear, and a solid square is formed.

FIGS. 6A to 6C are illustrations showing examples of display images reduced using the reduction algorithm of the control section 1.

FIG. 6A shows a display image before reduction processing, in which a circle, a cross laid out in the circle, and two triangles are displayed, like the display picture shown in FIG. 4A.

When the display image shown in FIG. 6A is reduced using the odd delete reduction algorithm, a display image shown in FIG. 6B is obtained. Referring to FIG. 6B, the cross and two triangles are displayed as barely recognizable patterns, though the circle is displayed as intermittent arcs.

When the display image shown in FIG. 6A is reduced by the even delete reduction algorithm, a display image shown in FIG. 6C is obtained. Referring to FIG. 6C, since the vertical and horizontal lines of the cross before reduction processing are formed by the dots of even-numbered row and column, the cross that should be at a position 111 completely disappears. Furthermore, as in FIG. 6B, the circle is displayed as intermittent arcs.

As described above, in the conventional display control apparatus, display image switching between enlargement/reduction display and normal display for displaying an image according to picture data in its original size is done by the control section 1 by rewriting the picture data in the VRAM 3. In this picture data rewrite, the picture data must be read out from the VRAM 3 and saved in the memory 5, or the saved picture data must be written back to the VRAM 3.

In the above-described portable device, for the purpose of reducing power consumption or cost, a microcomputer or the like that operates at a relatively low speed is used as the control section 1 to control the respective functions of the portable device. This requires a long time to rewrite picture data, including saving picture data in the memory 5 or writing back the data to the VRAM 3. For this reason, it is impossible to switch instantaneously between the display image for normal display and that for enlargement/reduction display.

As a solution to this problem, a microcomputer that operates at a high speed may be used for control. However, it is not practical to use a microcomputer that operates at a high speed in a portable device because power consumption must be suppressed. Additionally, use of a high-speed microcomputer increases the cost.

To switch between the display image for normal display and that for enlargement/reduction display, the picture data in the VRAM 3 is rewritten. To restore the display image for normal display, the memory 5 for saving the picture data for normal display must be prepared. This increases the memory capacity necessary for the portable device, makes it impossible to attain a lightweight and compact portable device, and also increases the cost.

In addition, as the algorithm for enlarging or reducing a display image, one algorithm prepared in advance as a program in the microcomputer or the like of a portable device has been used. Hence, the user can see only a display image enlarged or reduced by the algorithm. For this reason, the user must see an image in which the intersection portion 82 of the cross is displayed as a solid portion, as shown in FIG. 4C, or the cross that should be at the position 111 is absent, as shown in FIG. 6C.

### SUMMARY OF THE INVENTION

It is an object of the present invention to switch instantaneously between a display image for normal display and that for enlargement/reduction display without rewriting picture data in a VRAM.

It is another object of the present invention to display an enlarged or reduced image easier to see.

According to the present invention, there is provided a display control apparatus characterized by comprising a picture processing section for performing at least one of enlargement processing and reduction processing for input picture data, and a display picture selecting section for selectively outputting one of the input picture data and picture data, processed by the picture processing section, on the basis of an input display picture selection signal.

As another characteristic feature of the present invention, the picture processing section comprises processing sections for parallelly performing at least one of the enlargement processing and reduction processing in accordance with different algorithms, and a processing selecting section for selectively outputting one of picture data, processed by the processing sections, on the basis of an input processing selection signal.

According to the present invention, there is also provided a display control method characterized by comprising the steps of performing at least one of enlargement processing and reduction processing for input picture data, and selecting and outputting one of the input picture data and picture data, which has undergone at least one of the enlargement processing and reduction processing, on the basis of an input display picture selection signal.

As another characteristic feature of the present invention, the method further comprises parallelly performing at least one of the enlargement processing and reduction processing in accordance with different algorithms, and selecting and outputting one of picture data, processed in accordance with the different algorithms, on the basis of an input processing selection signal.

According to the present invention with the above construction, input picture data is subjected to one of enlargement processing and reduction processing, and one of the input picture data and picture data which has undergone at least one of enlargement processing and reduction processing is selected and output on the basis of a display picture selection signal. With this construction, while keeping the input picture data displayed, the picture data obtained by performing at least one of enlargement processing and reduction processing can be always generated. For this reason, the display image in the normal display and that in the enlargement display or reduction display can be instantaneously switched only selecting one of the display modes.

Hence, the memory for saving the picture data in the normal display is unnecessary. In addition, since switching between the display image in the normal display and that in the enlargement display or reduction display can be instantaneously done without using a high-speed microcomputer, a lightweight and inexpensive device can be attained.

Furthermore, when at least one of enlargement processing and reduction processing is parallelly performed by different algorithms, and one of picture data processed by the different algorithms is selected and output on the basis of an input processing selection signal, the picture data obtained by processing the input picture data by the different algorithms can be generated and displayed. For this reason, picture data processed by an algorithm suitable for a portion of interest in the input picture data can be selectively displayed.

### BRIEF DESCRIPTION OF THE DRAWINGS

FIG. 1 is a block diagram showing the construction of a conventional display control apparatus;

FIGS. 2A and 2B are illustrations showing an example of conventional display picture;

FIGS. 3A to 3C are illustrations showing examples of enlargement algorithms;

FIGS. 4A to 4C are illustrations showing examples of display images enlarged using the enlargement algorithms shown in FIGS. 3A to 3C;

FIGS. 5A to 5C are illustrations showing examples of reduction algorithms;

FIGS. 6A to 6C are illustrations showing examples of display images reduced using the reduction algorithms shown in FIGS. 5A to 5C;

FIG. 7 is a block diagram showing the construction of a display control apparatus according to the first embodiment of the present invention;

FIG. 8 is a block diagram showing an example of construction of the enlargement processing selecting section shown in FIG. 7;

FIGS. 9A to 9C are illustrations showing examples of display images enlarged by the display control apparatus according to the first embodiment;

FIG. 10 is a block diagram showing the construction of a display control apparatus according to the second embodiment of the present invention; and

FIGS. 11A to 11C are illustrations showing examples of display images reduced by the display control apparatus according to the second embodiment.

### DETAILED DESCRIPTION OF THE PREFERRED EMBODIMENTS

Embodiments of the present invention will be described below with reference to drawings.

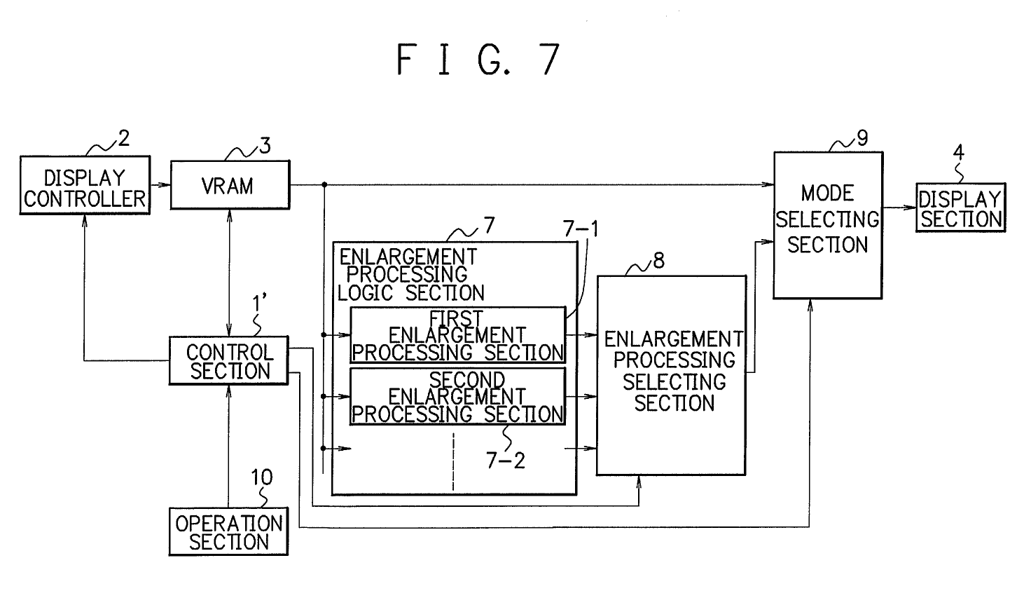

FIG. 7 is a block diagram showing the construction of a display control apparatus according to the first embodiment of the present invention. The display control apparatus shown in FIG. 7 can be suitably used when the size of picture data storable in a VRAM 3 equals the size of picture data displayable in the display picture of a display section 4.

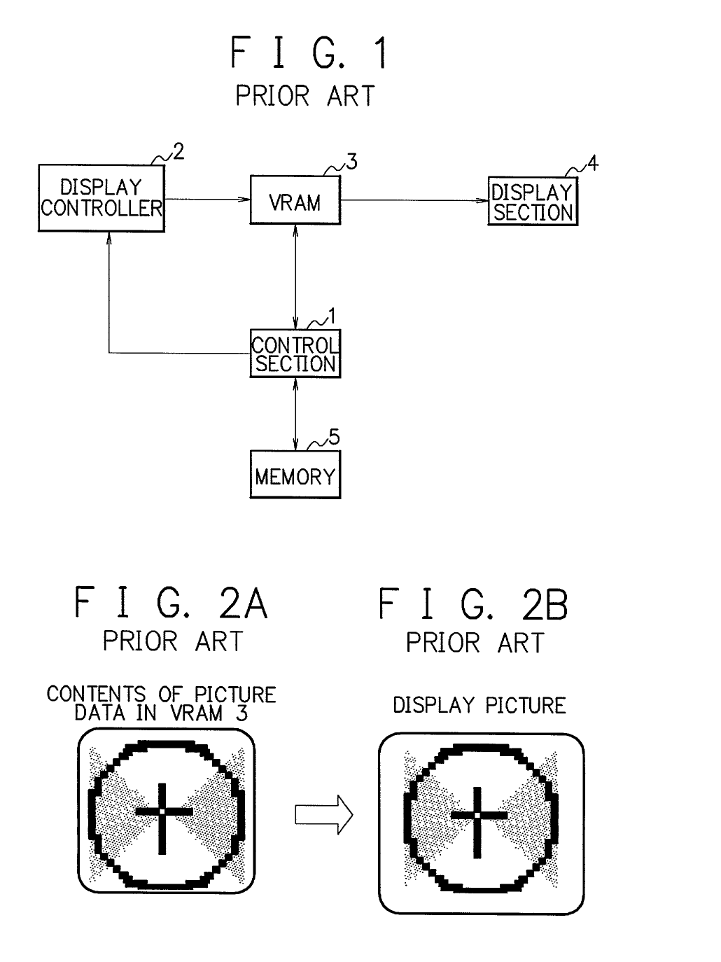

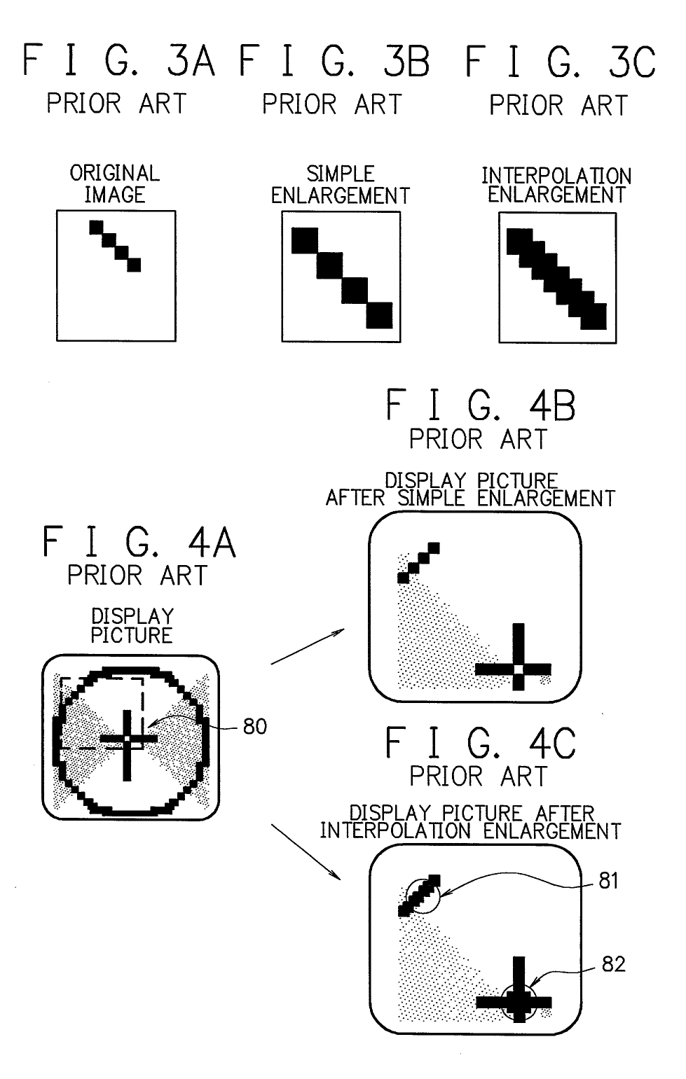

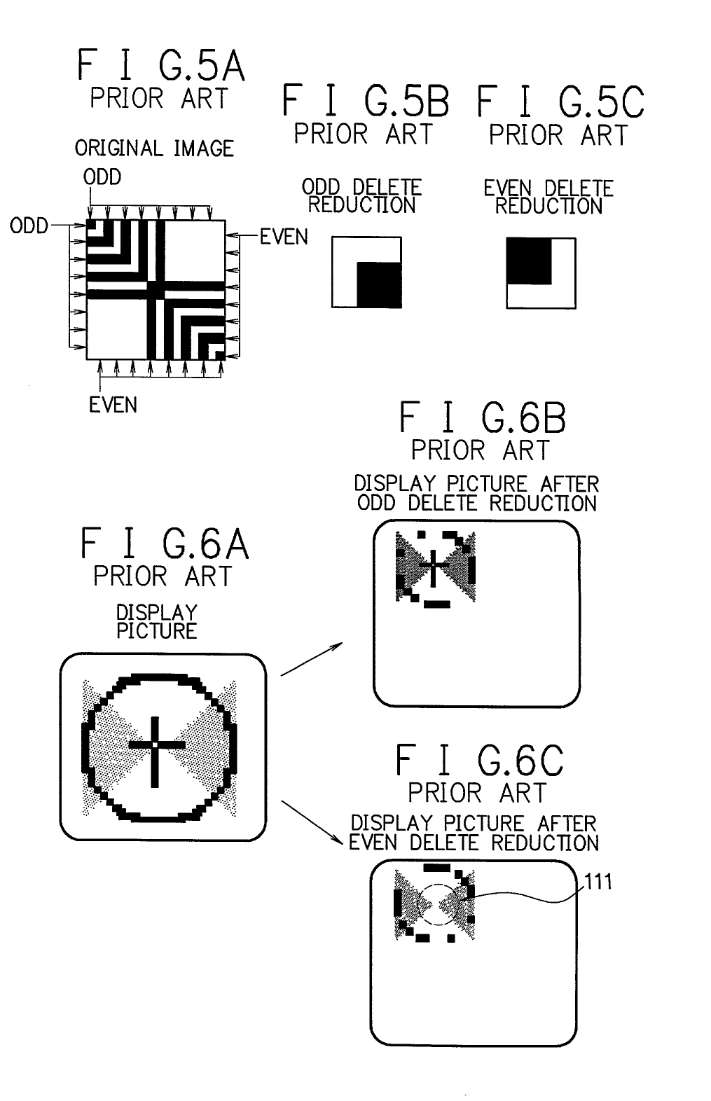

The same reference numerals as in FIG. 1 denote the same blocks in FIG. 7, and a detailed description thereof will be omitted. A block which is not the same but has the same function as in FIG. 1 is denoted by a reference numeral with prime (′)

A control section 1′ supplies the picture data of a display image to be displayed on a display section 4 to the VRAM 3 or instructs a display controller 2 to output the address of the VRAM 3, at which the picture data is stored. The control section 1′ also supplies an enlargement processing selection signal for selecting an enlargement algorithm to an enlargement processing selecting section 8. The control section 1′ also supplies, to a mode selecting section 9, a display mode selection signal for selecting one of the normal display mode for displaying picture data output from the VRAM 3 on the display section 4 without any change, and an enlargement display mode for displaying, on the display section 4, picture data obtained by executing enlargement processing for picture data output from the VRAM 3. The control section 1′ constitutes the control section of the present invention.

An enlargement processing logic section 7 executes predetermined enlargement processing for picture data output from the VRAM 3. This enlargement processing logic section 7 comprises a first enlargement processing section 7-1, second enlargement processing section 7-2, . . . . Each of the first enlargement processing section 7-1, second enlargement processing section 7-2, . . . has an enlargement algorithm for enlarging a display image and is formed by a logic circuit and the like. For example, the first enlargement processing section 7-1 has a simple enlargement algorithm for faithfully enlarging an image by a predetermined magnification in the vertical and horizontal directions. The second enlargement processing section 7-2 has an interpolation enlargement algorithm for vertically and horizontally enlarging an image and also executing interpolation processing. The first enlargement processing section 7-1, second enlargement processing section 7-2, . . . constitute the enlargement processing section of the present invention.

The enlargement processing selecting section 8 selects and outputs one of picture data which have undergone enlargement processing by the first enlargement processing section 7-1, second enlargement processing section 7-2, . . . . The enlarged picture data is selected on the basis of an enlargement processing selection signal supplied from the control section 1′. The enlargement processing selecting section 8 constitutes the enlargement processing selecting section of the present invention. The enlargement processing logic section 7 and enlargement processing selecting section 8 constitute the enlarged picture processing section of the present invention.

The mode selecting section 9 selects, which of a normal display image and an enlargement display image is to be displayed on the display section 4, on the basis of a display mode selection signal supplied from the control section 1′. More specifically, the mode selecting section 9 selects picture data supplied from the VRAM 3 or picture data supplied from the enlargement processing selecting section 8 on the basis of a display mode selection signal supplied from the control section 1′, and outputs the picture data to the display section 4. The mode selecting section 9 constitutes the display picture selecting section of the present invention.

An operation section 10 causes the user to select an enlargement algorithm for enlarging a display image or select which of a normal display image and an enlargement display image is to be displayed on the display section 4. The operation section 10 is formed from push buttons and the like. When the operation section 10 is operated by the user, the control section 1′ is notified of the operation by a predetermined signal.

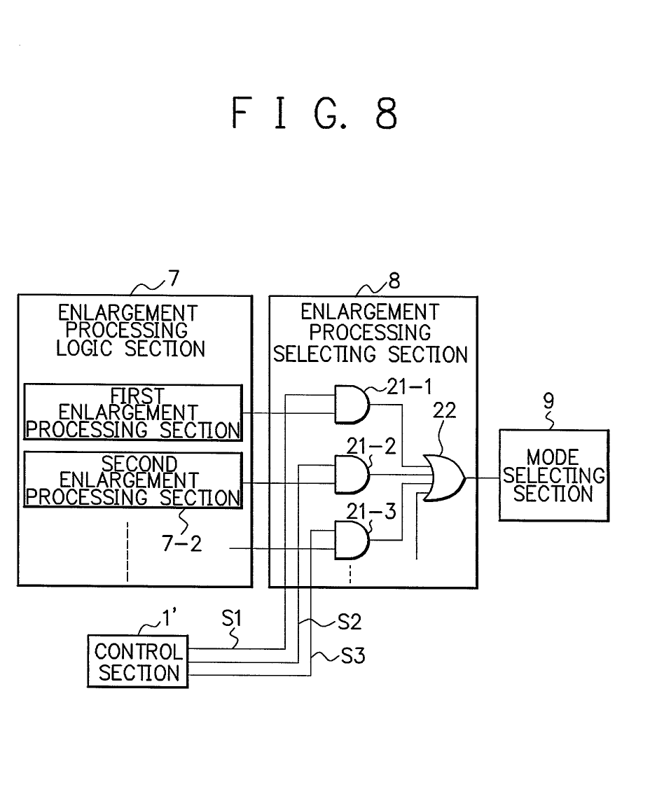

FIG. 8 is a block diagram showing the construction of the enlargement processing selecting section 8 shown in FIG. 7.

Referring to FIG. 8, reference symbols S1, S2, S3, . . . denote enlargement processing selection signals for selecting an enlargement algorithm. The enlargement processing selecting section 8 is constructed by AND circuits 21-1, 21-2, 21-3, . . . and one OR circuit 22. The AND circuits 21-1, 21-2, 21-3, . . . receive outputs from the enlargement processing sections 7-1, 7-2, . . . in the enlargement processing logic section 7, respectively, and also receive the enlargement processing selection signals S1, S2, S3, . . . from the control section 1′, respectively. For example, the AND circuit 21-1 receives the output from the first enlargement processing section 7-1 and the first enlargement processing selection signal S1. The OR circuit 22 receives the outputs from the AND circuits 21-1, 21-2, 21-3, . . . and outputs the arithmetic result to the mode selecting section 9.

When the user operates the push button or the like of the operation section 10 to input an instruction for selecting an enlargement algorithm, an instruction signal for instructing which enlargement algorithm is to be selected is sent from the operation section 10 to the control section 1′. Upon receiving the notification, the control section 1′ sets one of the enlargement processing selection signals S1, S2, S3, . . . at high level.

For example, assume that the first enlargement processing selection signal S1 goes high. At this time, since the remaining enlargement processing selection signals S2, S3, . . . are at low level, all the outputs from the AND circuits 21-2, 21-3, . . . except the AND circuit 21-1 which receives the first enlargement processing selection signal S1 are at low level. The AND circuit 21-1 directly outputs the input from the first enlargement processing section 7-1. In this way, an enlargement algorithm is selected by setting one of the enlargement processing selection signals at high level.

The mode selecting section 9 is formed from two AND circuits and one OR circuit. One AND circuit receives the output from the VRAM 3 and a display mode selection signal for selecting the normal display mode. The other AND circuit receives the output from the enlargement processing selecting section 8 and a display mode selection signal for selecting the enlargement display mode.

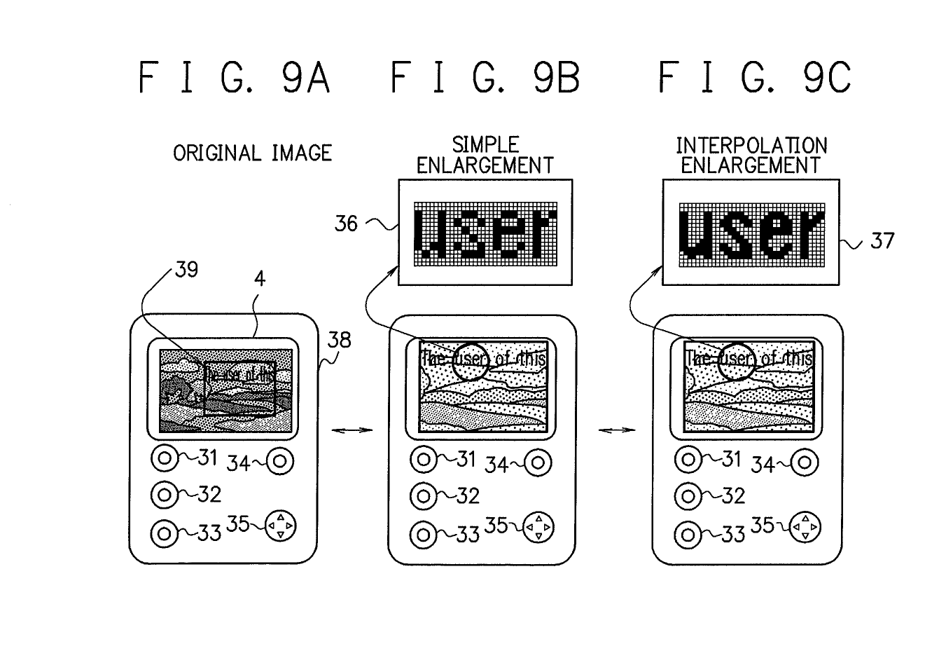

The operation of the display control apparatus shown in FIG. 7 will be described next with reference to FIGS. 9A to 9C.

FIGS. 9A to 9C are illustrations showing examples of display images enlarged by the display control apparatus according to the first embodiment.

Referring to FIGS. 9A to 9C, reference numeral 38 denotes a portable device such as a PDA; and 31, 32, and 33, push buttons for causing the enlargement processing selecting section 8 shown in FIG. 7 to select an enlargement algorithm. When the push button 31 is pressed, picture data enlarged by the first enlargement processing section 7-1 is selected by the enlargement processing selecting section 8. When the push button 32 is pressed, picture data enlarged by the second enlargement processing section 7-2 is selected. When the push button 33 is pressed, picture data enlarged by the third enlargement processing section (not shown) is selected.

That is, when the push buttons 31 to 33 are operated, one of the enlargement processing selection signals S1, S2, and S3 goes high accordingly and is output from the control section 1′ to the enlargement processing selecting section 8. In the initial state, picture data enlarged by the first enlargement processing section 7-1 is selected by the enlargement processing selecting section 8.

A push button 34 causes the mode selecting section 9 to select which of a normal display image and an enlargement display image is to be displayed on the display section 4. When this push button 34 is operated, the display image is switched. In the initial state, the mode is switched to display a normal display image.

A cursor key 35 is used to designate an image region to be enlarged in enlarging the display image.

First, the control section 1′ writes, in the VRAM 3, the picture data of a display image to be displayed on the display section 4. When the control section 1′ instructs the display controller 2 to output the address of the VRAM 3, at which the picture data is stored, the display controller 2 outputs the address to the VRAM 3. Upon receiving the address from the display controller 2, the VRAM 3 outputs picture data stored at that address.

The picture data output at this time is supplied to the mode selecting section 9 and the first enlargement processing section 7-1, second enlargement processing section 7-2, . . . . When the picture data is supplied from the VRAM 3, the first enlargement processing section 7-1, second enlargement processing section 7-2, . . . parallelly execute enlargement processing for the supplied picture data in accordance with the enlargement algorithms of their own. The enlarged picture data are output from the first enlargement processing section 7-1, second enlargement processing section 7-2, . . . to the enlargement processing selecting section 8.

In the initial state, the enlargement processing selecting section 8 selects the output from the first enlargement processing section 7-1. Hence, the picture data output from the first enlargement processing section 7-1 is output to the mode selecting section 9.

In the initial state, the mode selecting section 9 outputs the picture data of a normal display image, i.e., the picture data supplied from the VRAM 3. Hence, the picture data supplied from the VRAM 3 is output from the mode selecting section 9 to the display section 4, so the image in the normal size is displayed on the display section 4, as shown in FIG. 9A.

In the state wherein the image is displayed in the normal size, as shown in FIG. 9A, when the user presses a picture selection button (not shown), the operation section 10 notifies the control section 1′ that the picture selection button is pressed. Upon receiving the notification, the control section 1′ causes the display section 4 to display a selection frame 39 for selecting an image region to be enlarged. The user operates the cursor key 35 to move the selection frame 39 to a desired position. Then, the user presses the push button 34 to determine the image region to be enlarged.

When the push button 34 is pressed, the operation section 10 notifies the control section 1′ that the push button 34 is pressed. Upon receiving the notification, the control section 1′ notifies the display controller 2 of the address of the determined image region. The display controller 2 outputs the address to the VRAM 3, and the VRAM 3 supplies picture data at that address to the mode selecting section 9 and the first enlargement processing section 7-1, second enlargement processing section 7-2, . . . .

The first enlargement processing section 7-1, second enlargement processing section 7-2, . . . parallelly execute enlargement processing for the picture data supplied from the VRAM 3 in accordance with the enlargement algorithms of their own. Hence, the enlarged picture data are output from the first enlargement processing section 7-1, second enlargement processing section 7-2, . . . to the enlargement processing selecting section 8.

Since the enlargement processing selecting section 8 is still set in the state wherein the output from the first enlargement processing section 7-1 is output, the picture data output from the first enlargement processing section 7-1 is output to the mode selecting section 9. In addition, when the push button 34 is pressed, a display mode selection signal is output from the control section 1′ to the mode selecting section 9 to select the output from the enlargement processing selecting section 8. Thus, the mode selecting section 9 is switched to output the picture data supplied from the enlargement processing selecting section 8, and an enlarged image is displayed on the display section 4, as shown in FIG. 9B.

When the enlargement algorithm of the first enlargement processing section 7-1 is a simple enlargement algorithm, an image obtained by simply enlarging the picture data in the image region designated by the selection frame 39 is displayed in FIG. 9B. For example, characters “user” in the display image shown in FIG. 9B are enlarged as indicated by reference numeral 36.

In the state wherein the display image shown in FIG. 9B is displayed, when the user presses the push button 32, the operation section 10 notifies the control section 1′ that the push button 32 is pressed. Upon receiving the notification, the control section 1′ outputs an enlargement processing selection signal to the enlargement processing selecting section 8 such that the picture data enlarged by the second enlargement processing section 7-2 is selected.

The enlargement processing selecting section 8 is switched to output the picture data enlarged by the second enlargement processing section 7-2. At this time, since the picture data output from the VRAM 3 does not change, the second enlargement processing section 7-2 has already output the enlarged picture data to the enlargement processing selecting section 8. For this reason, simultaneously with the switching of the enlargement processing selecting section 8, the picture data enlarged by the second enlargement processing section 7-2 is output from the enlargement processing selecting section 8 and output to the display section 4 through the mode selecting section 9. Thus, the display image shown in FIG. 9C is displayed on the display section 4.

When the enlargement algorithm of the second enlargement processing section 7-2 is an interpolation enlargement algorithm, an image obtained by enlarging and interpolating the picture data in the image region designated by the selection frame 39 in FIG. 9A is displayed in FIG. 9C. For example, characters “user” in the display image shown in FIG. 9C are enlarged as indicated by reference numeral 37.

When the push button 31 is pressed in this state, the same processing as described above is executed, and the display image shown in FIG. 9B is immediately displayed on the display section 4.

As described above in detail, according to this embodiment, the first enlargement processing section 7-1, second enlargement processing section 7-2, . . . execute enlargement processing for picture data supplied from the VRAM 3 using the enlargement algorithms of their own and output the picture data to the enlargement processing selecting section 8.

The enlargement processing selecting section 8 selects the enlarged picture data on the basis of an enlargement processing selection signal supplied from the control section 1′ and outputs the picture data to the mode selecting section 9. The mode selecting section 9 selects one of the picture data supplied from the VRAM 3 and that supplied from the enlargement processing selecting section 8 on the basis of a display mode selection signal supplied from the control section 1′, and outputs the picture data to the display section 4.

With this construction, while the picture data supplied from the VRAM 3 is being displayed on the display section 4, the first enlargement processing section 7-1, second enlargement processing section 7-2, . . . can execute enlargement processing for the picture data supplied from the VRAM 3, and output the enlarged picture data to the mode selecting section 9 through the enlargement processing selecting section 8. Hence, the normal display image and enlargement display image can be instantaneously switched only by switching the mode selecting section 9 without rewriting the picture data in the VRAM 3.

Since the display image can be switched without rewriting data in the VRAM 3, the memory for saving the data in the VRAM 3 is unnecessary. In addition, switching of the display image can be instantaneously done without using a high-speed microcomputer.

The first enlargement processing section 7-1, second enlargement processing section 7-2, . . . parallelly execute enlargement processing for picture data supplied from the VRAM 3 in accordance with the enlargement algorithms of their own and output the picture data to the enlargement processing selecting section 8. The enlargement processing selecting section 8 selects one of the picture data enlarged by the first enlargement processing section 7-1, second enlargement processing section 7-2, . . . on the basis of an enlargement processing selection signal supplied from the control section 1′, and outputs the picture data to the mode selecting section 9.

With this construction, since the enlargement processing selecting section 8 can select one of the picture data obtained by enlarging the picture data supplied from the VRAM 3 in accordance with the enlargement algorithms of the first enlargement processing section 7-1, second enlargement processing section 7-2, . . . and output the picture data to the mode selecting section 9, the user can select an enlargement algorithm suitable for a portion of interest defined by the selection frame 39 by comparing the images enlarged by the enlargement algorithms with each other. Hence, an enlarged image easier to see can be selected and displayed for each region of user's interest.

The second embodiment of the present invention will be described next.

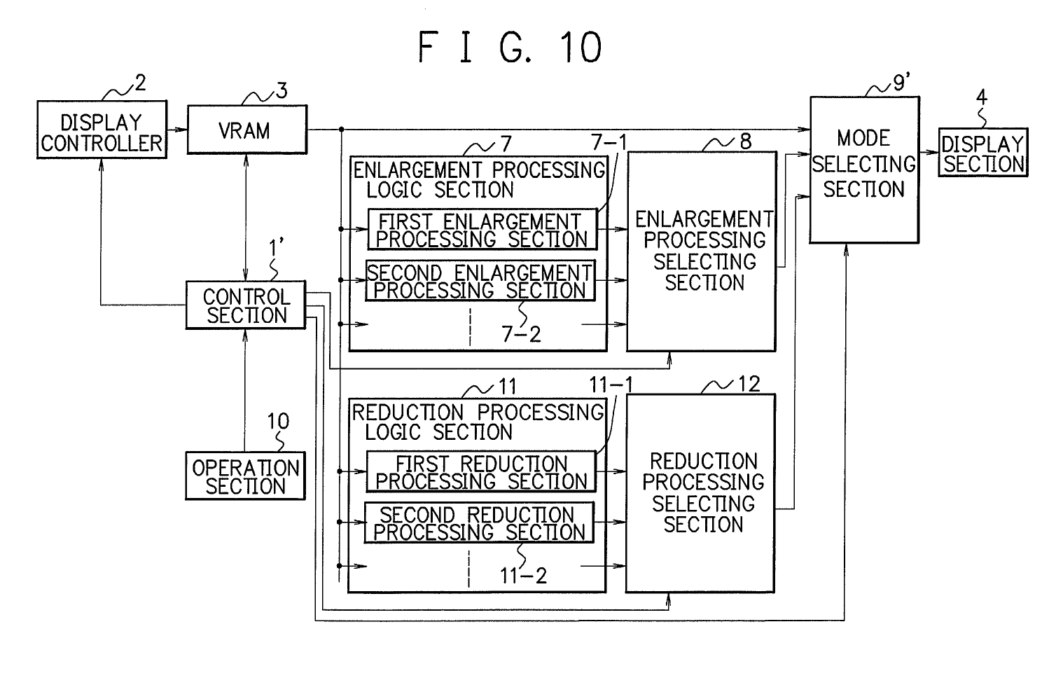

FIG. 10 is a block diagram showing the construction of a display control apparatus according to the second embodiment. The display control apparatus shown in FIG. 10 can be suitably used when the size of picture data storable in a VRAM 3 is larger than the size of picture data displayable in the display picture of a display section 4.

The same reference numerals as in FIG. 7 denote the same blocks in FIG. 10, and a detailed description thereof will be omitted. A block which is not the same but has the same function as in FIG. 7 is denoted by a reference numeral with prime (′).

A mode selecting section 9′ selects, which of a normal display image, an enlargement display image, and a reduction display image which has undergone reduction processing is to be displayed on the display section 4, on the basis of a display mode selection signal supplied from a control section 1′. More specifically, the mode selecting section 9 selects picture data supplied from the VRAM 3, picture data supplied from an enlargement processing selecting section 8, and picture data supplied from a reduction processing selecting section 12, on the basis of a display mode selection signal supplied from the control section 1′, and outputs the picture data to the display section 4.

A reduction processing logic section 11 executes predetermined reduction processing for picture data output from the VRAM 3. This reduction processing logic section 11 comprises a first reduction processing section 11-1, second reduction processing section 11-2, . . . . Each of the first reduction processing section 11-1, second reduction processing section 11-2, . . . has a reduction algorithm for reducing a display image and is formed by a logic circuit and the like.

For example, the first reduction processing section 11-1 has an odd delete reduction algorithm for deleting dots of odd-numbered rows and columns of a display image. The second reduction processing section 11-2 has an even delete reduction algorithm for deleting dots of even-numbered rows and columns of a display image. The first reduction processing section 11-1, second reduction processing section 11-2, . . . constitute the reduction processing section of the present invention.

The reduction processing selecting section 12 selects and outputs one of picture data which have undergone reduction processing by the first reduction processing section 11-1, second reduction processing section 11-2, . . . . The reduced picture data is selected on the basis of a reduction processing selection signal supplied from the control section 1′. The reduction processing selecting section 12 constitutes the reduction processing selecting section of the present invention. The reduction processing logic section 11 and reduction processing selecting section 12 constitute the reduced picture processing section of the present invention.

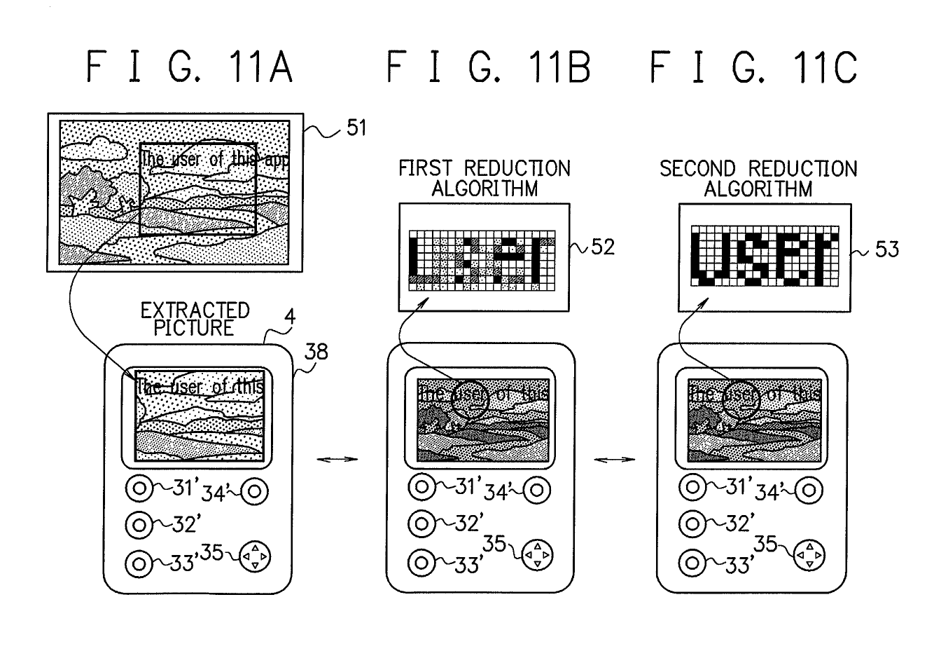

The operation of the display control apparatus shown in FIG. 10 will be described next with reference to FIGS. 11A to 11C.

The enlargement processing operation of the display control apparatus shown in FIG. 10 is the same as that of the display control apparatus shown in FIG. 7, and a detailed description thereof will be omitted.

FIGS. 11A to 11C are illustrations showing examples of display images reduced by the display control apparatus according to the second embodiment. In the examples of image display shown in FIGS. 11A to 11C, reduction processing executed when the picture size of picture data stored in the VRAM 3 is larger than the size of the display picture, e.g., when an image having a VGA size (640×480 dots) is to be displayed in a picture having a QVGA size (320×240 dots) will be described.

Referring to FIGS. 11A to 11C, reference numeral 38 denote a portable device such as a PDA; and 31′, 32′, and 33′, push buttons. When enlargement display is being performed, the push buttons 31′ to 33′ are used to cause the enlargement processing selecting section 8 to select an enlargement algorithm. When reduction display is being performed, the buttons 31′ to 33′ are used to cause the reduction processing selecting section 12 to select a reduction algorithm.

For example, when the push button 31′ is pressed in the reduction display mode, picture data reduced by the first reduction processing section 11-1 shown in FIG. 10 is selected by the reduction processing selecting section 12. When the push button 32′ is pressed in the reduction display mode, picture data reduced by the second reduction processing section 11-2 is selected. When the push button 33′ is pressed in the reduction display mode, picture data reduced by a third reduction processing section (not shown) is selected.

That is, when the push buttons 31′ to 33′ are operated in the reduction display mode, one of reduction processing selection signals goes high and is output from the control section 1′ to the reduction processing selecting section 12.

In the enlargement display mode as well, picture data enlarged by the first enlargement processing section 7-1, second enlargement processing section 7-2, or third enlargement processing section (not shown) is selected by the push buttons 31′ to 33′.

A push button 34′ is used to cause the mode selecting section 9′ to select which of a normal display image, enlargement display image, and reduction display image is to be displayed on the display section 4. When the push button 34′ is operated, the display image is switched. For example, every time the push button 34′ is pressed, the display image is switched as normal display image→enlargement display image→ reduction display image →normal display image→ . . . .

A cursor key 35 is used to designate an image region to be enlarged or reduced in enlarging or reducing the displayed image.

The operation after the control section 1′ writes, in the VRAM 3, the picture data of an image to be displayed on the display section 4 and until the picture data is output from the VRAM 3 is the same as that of the display control apparatus according to the first embodiment shown in FIG. 7.

The picture data output from the VRAM 3 is supplied to the mode selecting section 9′, a first enlargement processing section 7-1, second enlargement processing section 7-2, . . . , and the first reduction processing section 11-1, second reduction processing section 11-2, . . . . When the picture data is supplied from the VRAM 3, the first reduction processing section 11-1, second reduction processing section 11-2, . . . parallelly execute reduction processing for the supplied picture data in accordance with the reduction algorithms of their own. The reduced picture data are output from the first reduction processing section 11-1, second reduction processing section 11-2, . . . to the reduction processing selecting section 12.

In a similar way, the first enlargement processing section 7-1, second enlargement processing section 7-2, . . . parallelly execute enlargement processing for the picture data supplied from the VRAM 3 and output the picture data to the enlargement processing selecting section 8.

In instructing the display controller 2 to output the address of the VRAM 3, at which the picture data is stored, the control section 1′ compares the picture size of the picture data with that of the display section 4. If it is determined that the picture size of the picture data is larger than that of the display section 4, the control section 1′ outputs a display mode selection signal to the mode selecting section 9′ to make it output picture data output from the reduction processing selecting section 12 to the display section 4. Hence, the display image reduced by the first reduction algorithm is displayed on the display section 4, as shown in FIG. 11B.

In the state wherein the reduced image is displayed, as shown in FIG. 11B, when the user presses a picture selection button (not shown), an operation section 10 notifies the control section 1′ that the picture selection button is pressed. Upon receiving the notification, the control section 1′ causes the display section 4 to display a selection frame for selecting an image region to be displayed as a normal display image. The user operates the cursor key 35 to move the selection frame to a desired position. Then, the user presses the push button 34′ to determine the image region to be displayed as a normal display image.

When the push button 34′ is pressed, the operation section 10 notifies the control section 1′ that the push button 341 is pressed. Upon receiving the notification, the control section 1′ notifies the display controller 2 of the address of the determined image region. The display controller 2 outputs the address to the VRAM 3. The VRAM 3 which has received the address supplies picture data at that address to the mode selecting section 9′, the first enlargement processing section 7-1, second enlargement processing section 7-2, . . . , and the first reduction processing section 11-1, second reduction processing section 11-2 . . . .

As in the above-described operation, the first enlargement processing section 7-1, second enlargement processing section 7-2, . . . enlarge the picture data supplied from the VRAM 3 and output the picture data to the enlargement processing selecting section 8. Similarly, the first reduction processing section 11-1, second reduction processing section 11-2, . . . output reduced picture data to the reduction processing selecting section 12.

When the push button 34′ is pressed, a display mode selection signal is output from the control section 1′ to the mode selecting section 9′ to select the picture data supplied from the VRAM 3. Thus, the mode selecting section 9′ is switched to output the picture data supplied from the VRAM 3 to the display section 4, and the image in the normal size is displayed on the display section 4, as shown in FIG. 11A.

In the state wherein the reduced image is displayed, as shown in FIG. 11B, when the user presses the push button 32′, the operation section 10 notifies the control section 1′ that the push button 32′ is pressed. Upon receiving the notification, the control section 1′ outputs a reduction processing selection signal to the reduction processing selecting section 12 to select the picture data reduced by the second reduction processing section 11-2. The reduction processing selecting section 12 is switched to output the picture data reduced by the second reduction processing section 11-2.

At this time, since the picture data output from the VRAM 3 does not change, the second reduction processing section 11-2 has already output the reduced picture data to the reduction processing selecting section 12. For this reason, simultaneously with the switching of the reduction processing selecting section 12, the picture data reduced by the second reduction processing section 11-2 is output from the reduction processing selecting section 12 and output to the display section 4 through the mode selecting section 9′. Thus, the display image reduced by the second reduction algorithm is displayed on the display section 4, as shown in FIG. 11C.

As described above, in the second embodiment, the enlargement processing sections 7-1, 7-2, . . . enlarge the picture data supplied from the VRAM 3 using the enlargement algorithms of their own and output the picture data to the enlargement processing selecting section 8. The enlargement processing selecting section 8 selects one of the enlarged picture data on the basis of an enlargement processing selection signal supplied from the control section 1′, and outputs the picture data to the mode selecting section 9′.

Similarly, the reduction processing sections 11-1, 11-2, . . . reduce the picture data supplied from the VRAM 3 using the reduction algorithms of their own and output the picture data to the reduction processing selecting section 12. The reduction processing selecting section 12 selects one of the reduced picture data on the basis of a reduction processing selection signal supplied from the control section 1′, and outputs the picture data to the mode selecting section 9′.

The mode selecting section 9′ selects one of the picture data supplied from the VRAM 3, the picture data supplied from the enlargement processing selecting section 8, and the picture data supplied from the reduction processing selecting section 12 on the basis of a display mode selection signal supplied from the control section 1′, and outputs the picture data to the display section 4.

With this construction, while the picture data supplied from the VRAM 3 is being displayed on the display section 4, the enlargement processing sections 7-1, 7-2, . . . can execute enlargement processing for the supplied picture data and output the picture data to the mode selecting section 9′ through the enlargement processing selecting section 8. Similarly, the reduction processing sections 11-1, 11-2, . . . can execute reduction processing for the supplied picture data and output the picture data to the mode selecting section 9′ through the reduction processing selecting section 12. Hence, the normal display image, enlargement display image, and reduction display image can be instantaneously switched only by switching the mode selecting section 9′ without rewriting the picture data in the VRAM 3.

Since the display image can be switched without rewriting data in the VRAM 3, the memory for saving the data in the VRAM 3 is unnecessary. In addition, switching of the display image can be instantaneously done without using a high-speed microcomputer.

The enlargement processing sections 7-1, 7-2, . . . parallelly execute enlargement processing for the supplied picture data in accordance with the enlargement algorithms of their own and output the picture data to the enlargement processing selecting section 8. The enlargement processing selecting section 8 selects one of the enlarged picture data on the basis of an enlargement processing selection signal supplied from the control section 1′ and outputs the picture data to the mode selecting section 9′. In a similar manner, the reduction processing sections 11-1, 11-2, . . . execute reduction processing for the supplied picture data in accordance with the reduction algorithms of their own and output the picture data to the reduction processing selecting section 12. The reduction processing selecting section 12 selects one of the reduced picture data on the basis of a reduction processing selection signal supplied from the control section 1′ and outputs the picture data to the mode selecting section 9′.

With this construction, the enlargement processing selecting section 8 can select one of the picture data obtained by enlarging the supplied picture data in accordance with the enlargement algorithms of the enlargement processing sections 7-1, 7-2, . . . and output the picture data to the mode selecting section 9′. In addition, the reduction processing selecting section 12 can select one of the picture data obtained by reducing the supplied picture data in accordance with the reduction algorithms of the reduction processing sections 11-1, 11-2, . . . and output the picture data to the mode selecting section 9′. Hence, the user can select an enlargement algorithm and reduction algorithm suitable for a portion of user's interest by comparing the images enlarged by the enlargement algorithms and the images reduced by the reduction algorithms with each other. Hence, an enlarged image or reduced image which is easier to see can be selected and displayed for each region of user's interest.

In the second embodiment, in addition to the first embodiment, the reduction processing sections 11-1, 11-2, . . . for reducing picture data are arranged. For this reason, even when the size of picture data displayable in the display picture of the display section 4 is smaller than the size of picture data in the VRAM 3, the picture data in the VRAM 3 can be reduced and displayed. Hence, the whole picture data can be seen at once.

In the above-described first and second embodiments, the push buttons 31 to 33 and 31′ to 33′ are used, and an enlargement algorithm or reduction algorithm is selected by making each of the push buttons 31 to 33 and 31′ to 33′ to correspond to one enlargement algorithm or reduction algorithm. However, using one push button, the enlargement algorithms and reduction algorithms may be sequentially switched and selected every time the push button is pressed.

The present invention is not limited to the above-described portable device and can also be applied to a display control apparatus for a device having limited CPU processing capability (operation speed) or limited memory capacity.

What is claimed is:

1. A display control apparatus comprising:
a picture processing section for performing processing for at least one of enlargement and reduction in relation to input picture data; and
a display picture selecting section for, in accordance with an input display picture selection signal, selecting and outputting one of said input picture data and picture data processed by said picture processing section.

2. The apparatus according to claim 1, wherein said picture processing section comprises:
processing sections for performing processing for at least one of enlargement and reduction, in parallel using different algorithms; and
a processing selecting section for, in accordance with an input processing selection signal, selecting and outputting the picture data processed by one of said processing sections.

3. the apparatus according to claim 2, further comprising a control section for outputting said display picture selection signal and said processing selection signal.

4. The apparatus according to claim 2, wherein each of said processing sections comprises a logic circuit.

5. The apparatus according to claim 2, wherein said processing selection signal comprises selection signals respectively corresponding to said processing sections, each of said selection signals being used for selecting the picture data processed by the corresponding processing section, and
said processing selecting section outputs the picture data selected in accordance with one of said selection signals.

6. The apparatus according to claim 5, wherein said processing selecting section comprises:
AND circuits each of which the picture data processed by one of said processing sections and the selection signal for selecting said picture data are input to, and
at least one OR circuit which the outputs of said AND circuits are input to.

7. A display control apparatus comprising:
processing sections for performing processing for at least one of enlargement and reduction in relation to input picture data, in parallel using different algorithms; and
a processing selecting section for, in accordance with an input processing selection signal, selecting and outputting the picture data processed by one of said processing sections.

8. A display control apparatus comprising:
a picture enlargement processing section for performing processing for enlargement in relation to input picture data;
a picture reduction processing section for performing processing for reduction in relation to said input picture data; and
a display picture selecting section for, in accordance with an input display picture selection signal, selecting and outputting one of said input picture data, the picture data processed for enlargement by said picture enlargement processing section, and the picture data processed for reduction by said picture reduction processing section.

9. The apparatus according to claim 8, wherein said picture enlargement processing section comprises:
enlargement processing sections for performing processing for enlargement in parallel using different enlargement algorithms; and
an enlargement processing selecting section for, in accordance with an input enlargement processing selection signal, selecting and outputting the picture data processed for enlargement by one of said enlargement processing sections.

10. The apparatus according to claim 9, wherein each of said enlargement processing sections comprises a logic circuit.

11. The apparatus according to claim 8, wherein said picture enlargement processing section comprises:
reduction processing sections for performing processing for reduction in parallel using different reduction algorithms; and
a reduction processing selecting section for, in accordance with an input reduction processing selection signal, selecting and outputting the picture data processed for reduction by one of said reduction processing sections.

12. The apparatus according to claim 11, wherein each of said reduction processing sections comprises a logic circuit.

13. The apparatus according to claim 8, wherein said picture enlargement processing section comprises:
enlargement processing sections for performing processing for enlargement in parallel using different enlargement algorithms; and
an enlargement processing selecting section for, in accordance with an input enlargement processing selection signal, selecting and outputting the picture data processed for enlargement by one of said enlargement processing sections, and
said picture enlargement processing section comprises:
reduction processing sections for performing processing for reduction in parallel using different reduction algorithms; and
a reduction processing selecting section for, in accordance with an input reduction processing selection signal, selecting and outputting the picture data processed for reduction by one of said reduction processing sections,
said enlargement processing sections and said reduction processing sections performing processing in parallel.

14. The apparatus according to claim 13, further comprising a control section for outputting said display picture selection signal, said enlargement processing selection signal, and said reduction processing selection signal.

15. The apparatus according to claim 13, wherein each of said enlargement processing sections and said reduction processing sections comprises a logic circuit.

16. The apparatus according to claim 13, wherein said enlargement processing selection signal comprises enlargement algorithm selection signals respectively corresponding to said enlargement processing sections, each of said enlargement algorithm selection signals being used for selecting the picture data processed for enlargement by the corresponding enlargement processing section, and
said enlargement processing selecting section outputs the picture data selected in accordance with one of said enlargement algorithm selection signals, and
said reduction processing selection signal comprises reduction algorithm selection signals respectively corresponding to said reduction processing sections, each of said reduction algorithm selection signals being used for selecting the picture data processed for reduction by the corresponding reduction processing section, and
said reduction processing selecting section outputs the picture data selected in accordance with one of said reduction algorithm selection signals.

17. The apparatus according to claim 16, wherein said enlargement processing selecting section comprises:
AND circuits each of which the picture data processed for enlargement by one of said enlargement processing sections and the enlargement algorithm selection signal for selecting said picture data are input to; and
at least one OR circuit which the outputs of said AND circuits are input to, and
said reduction processing selecting section comprises:
AND circuits each of which the picture data processed for reduction by one of said reduction processing sections and the reduction algorithm selection signal for selecting said picture data are input to; and
at least one OR circuit which the outputs of said AND circuits are input to.

18. A display control method comprising the steps of:
performing processing for at least one of enlargement and reduction in relation to input picture data; and,
in accordance with an input display picture selection signal, selecting and outputting one of said input picture data and picture data processed for at least one of enlargement and reduction.

19. The method according to claim 18, wherein processing for at least one of enlargement and reduction is performed in parallel using different algorithms, and the picture data processed in accordance with one of said different algorithms is selected and output in accordance with an input processing selection signal.
